(19) United States
(12) Patent Application Publication
(10) Pub. No.: US 2016/0171517 A1
(43) Pub. Date: Jun. 16, 2016

(54) SYSTEMS AND METHODS FOR USER-BASED MARKETING

(71) Applicant: Anupama Dochibhotla Malladi, San Diego, CA (US)

(72) Inventor: Anupama Dochibhotla Malladi, San Diego, CA (US)

(21) Appl. No.: 14/963,191

(22) Filed: Dec. 8, 2015

Related U.S. Application Data
(60) Provisional application No. 62/091,014, filed on Dec. 12, 2014.

(51) Int. Cl. G06Q 30/02

(52) U.S. Cl. CPC G06Q 30/0214; G06Q 30/0246

(57) ABSTRACT

Methods, systems, means and machine-readable media embodying program instructions for rewarding users who promote a product or service that is purchased by a purchaser are described. Certain methods may identify a total reward amount or points associated with a promotion, identify when a product or service is purchased by a purchaser using the promotion; identify a first group of users who each provided the promotion to the purchaser before the purchase, and determine a percentage of the total reward amount or points that is owed to each user.

### FIELD

Various embodiments relate to targeted marketing, and more particularly, to systems, methods and machine-readable media for analyzing and tracking distribution of reward amounts or points for user referrals in targeted marketing.

### BACKGROUND

For years, businesses have struggled to isolate consumers who are likely to purchase goods and services from consumers who are unlikely to purchase the marketed goods and services. Businesses spend significant amounts on marketing campaigns to promote the goods and services to likely purchasers but fail to get the exact statistics of how many purchasers were actually reached by the particular marketing campaign. Described below are new and improved approaches to connect a likely purchaser with a business's goods and services and improve the effectiveness of marketing analytics.

### SUMMARY

Various embodiments of this disclosure relate generally to systems (e.g., networks, devices, or device components), methods and machine-readable media for tracking user activity in relation to promoting a product or service that is purchased by a purchaser. Such systems, methods and machine-readable media may identify a total reward amount or points associated with a promotion, identify when a product or service is purchased by a purchaser using the promotion, identify a first group of users who each provided the promotion to the purchaser before the purchase, and determine a percentage of the total reward amount or points that is owed to each user in the first group.

The details of one or more embodiments of the invention are set forth in the accompanying drawings and the description below. Other features, objects, and advantages of the invention will be apparent from the description, drawings, and claims.

### BRIEF DESCRIPTION OF THE DRAWINGS

FIG. 1A illustrates a network where users directly or indirectly forward the promotion to a purchaser that uses the promotion to purchase a product/service form a business, and the business provides a reward to the users who forwarded the promotion.

FIG. 1B illustrates a more complicated network where various users directly or indirectly forward the same promotion to a purchaser and potentially to other users.

FIG. 2A depicts a network of platforms that are used by various entities to carry out operations like forwarding a promotion, tracking forwarding and recipient users of the promotion, tracking use of the promotion by a purchaser user, identifying parameters used to determine reward amounts or points for forwarding users, and determining reward amounts or points for forwarding users.

FIG. 2B depicts different features that may be incorporated into the platforms of FIG. 2A.

FIG. 2C depicts one implementation of the platforms of FIG. 2A.

FIG. 3 depicts a process flow for determining reward amounts or points for different users who each forwarded a promotion to a purchaser who used that promotion.

FIG. 4 depicts a process flow for determining allocations of a reward amount or points for different levels of forwarding users, and for determining different portions of each allocation at each level for different users at that level.

FIG. 5A through FIG. 5B depict process flows for determining allocations of a reward amount or points for different levels.

FIG. 6A through FIG. 6B depict process flows for determining different portions of each allocation at each level for different users at that level.

FIG. 7 pictorially depicts aspects of the process flows in FIG. 4 through FIG. 6B.

FIG. 8A depicts a high-level representation of data collected in relation to forwarding of a promotion by users before a purchase occurs in association with that promotion, where actual implementations of the data may vary.

FIG. 8B depicts a high-level representation of data collected and/or generated after a purchase, where actual implementations of the data may vary.

FIG. 9 depicts a process flow for determining a hierarchy of user nodes associated with a purchaser node, and also for determining reward amounts or points for each ancestor node based on the level and degree of forwarding for that ancestor node.

FIG. 10 illustrates a hierarchy of user nodes associated with different combinations of parameters that specify a level and a degree of forwarding for each ancestor node.

Like reference numbers and designations in the drawings indicate like elements.

### DETAILED DESCRIPTION

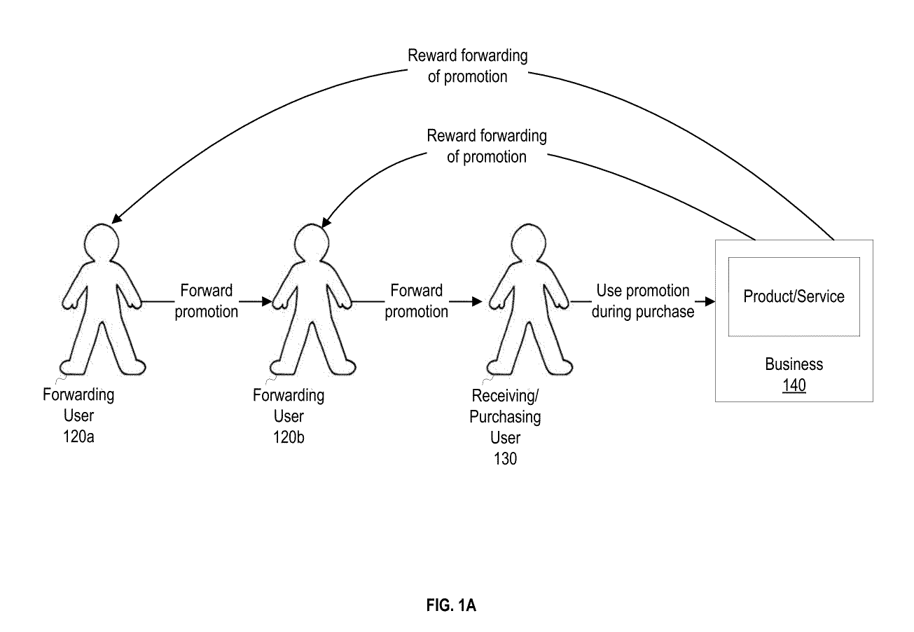

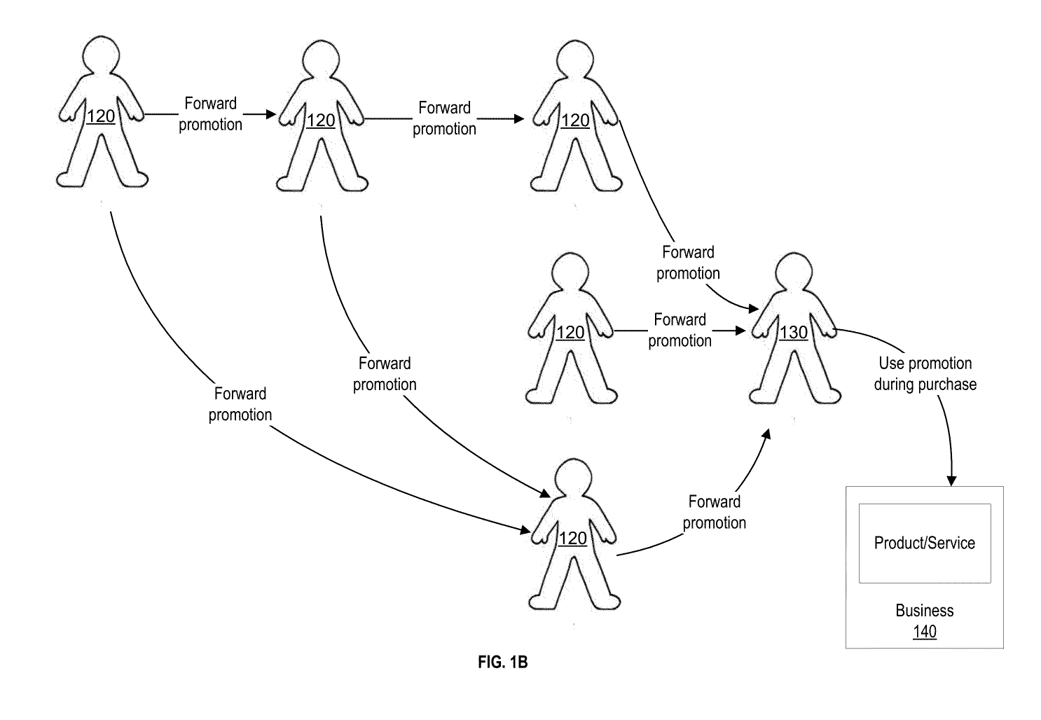

FIG. 1A illustrates a network where users directly or indirectly forward the promotion to a purchaser that uses the promotion to purchase a product/service through a business, after which the business provides a reward to the users who forwarded the promotion. As shown in FIG. 1A, a forwarding user 120a forwards a promotion to another forwarding user 120b, who in turn forwards the promotion to a purchaser user 130. The purchaser user 130 uses the promotion to purchase a product or service offered by a business 140, after which the business 140 rewards each of the forwarding users 120a-b for their efforts in forwarding the promotion.

The reward for each forwarding user 120 may vary. In one embodiment, the reward for each forwarding user 120 is a portion of a total reward amount (e.g., an amount of currency, an amount of store credit, or another redeemable amount). In another embodiment, the reward for each forwarding user 120 is a portion of a total reward points (e.g., points of a credit card, points of a corporation or a group of corporations, or other redeemable points). The portion may be the same for each of the users 120a-b, or it may be different. Of course, more forwarding users 120 may participate, as illustrated in FIG. 1B and described below.

FIG. 1B illustrates a more complicated network where various users directly or indirectly forward the same promotion to a purchaser and potentially to other users. As shown in FIG. 1B, the promotion may be forwarded through multiple forwarding pathways that involve different or common users 120, such that a purchaser user 130 may receive the promotion from different forwarding users 120, who each received the promotion from the same and/or different forwarding users 120 before forwarding the promotion to the purchaser user 130.

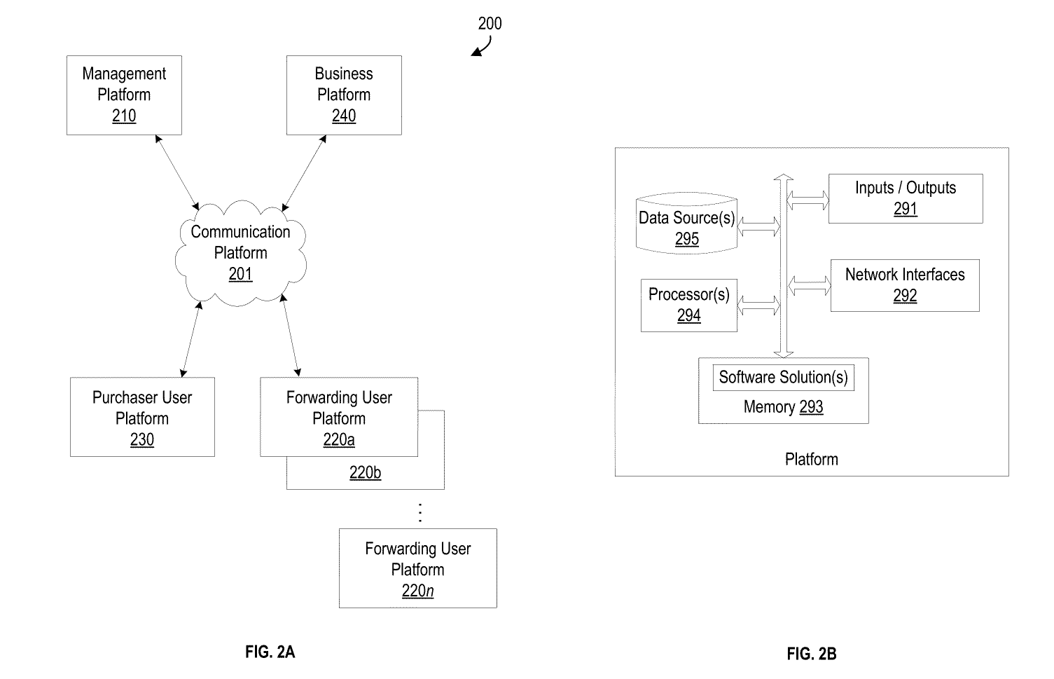

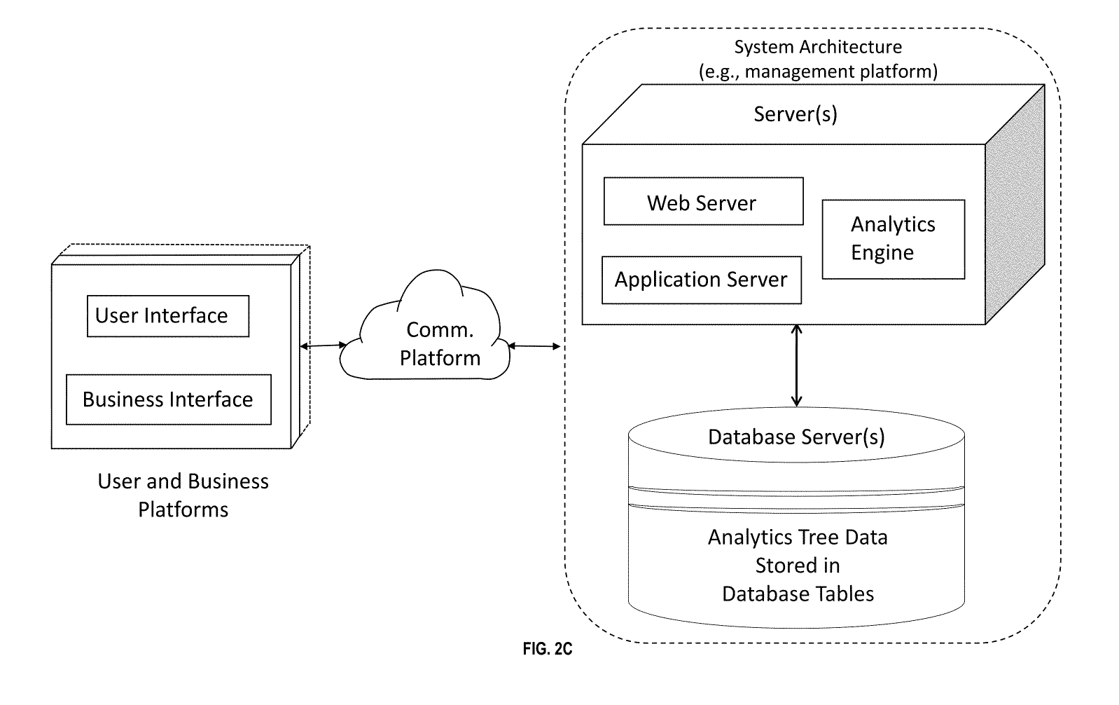

Attention is now drawn to FIG. 2A, which depicts a system 200 of platforms that are used by the various entities 120, 130 and 140 shown in FIG. 1A and FIG. 1B to carry out operations like forwarding a promotion, tracking forwarding users and recipient users of the promotion, tracking use of the promotion by the purchaser user, identifying parameters used to determine reward amounts or points for each forwarding user (e.g., a level at which the promotion was forwarded and/or a degree of forwarding), and determining the reward amounts or points for each forwarding user.

The system 200 may include various platforms, including a communication platform 201, a management platform 210, one or more forwarding user platforms 220a-n, a purchaser user platform 230, and a business platform 240. The term “platform” as used herein may refer to a single device or component, or a grouping of devices or components at the same location or different locations. A platform may include components or devices that may be hosted by parties other than those directly associated with the labeling of each platform. Examples of such components and devices include cloud-based services like remote data sources and servers. Each platform may include hardware, software, firmware or other components that receive, process, store and send data. Certain platforms may include any suitable computing device like a server, personal computer, hand-held or laptop device, mobile phone, touch-screen computing device, and programmable consumer electronic device. The platforms may use various software applications, web browsers, mail clients, and messaging clients including those that operate in conjunction with web connectivity through a local area network connection or radio link, and those that operate without web connectivity.

In some embodiments, the management platform 210, forwarding user platform 220, purchaser user platform 230, and the business platform 240 each may include various components, including some or all of those depicted in FIG. 2B. As shown, FIG. 2B depicts input/output interface(s) 291 (e.g., keyboard, touch screen, speaker, microphone, or any other interface), network interface(s) 292 (e.g., wired and wireless means like radio antennas, USB ports, or any other transceiving hardware), temporary or long term memory 293, processor(s) (or other computing components) 294, and data source(s) 295 that include one or more storage devices. Each data source may be a single storage device or realized by multiple (e.g., distributed) storage devices. Similarly, each processor may be a single processor or realized by multiple (e.g., distributed) processors.

The platforms may further include a software solution stored in the memory 293, where the processor 294 executes instructions embodied in the software solution to implement any of the operations disclosed herein. Certain aspects of each platform are described in more detail below. It is to be understood that the description herein is not intended to be limiting, and alternative embodiments are contemplated as understood by one of skill.

FIG. 2C depicts one implementation of the platforms of FIG. 2A. As shown, user and business platforms communicate with a management platform via a communication platform. The management platform is shown to include a web server, application server and analytics engine, and database tables that are each operable to carryout aspects disclosed herein.

### Communication Platform 201

The communication platform 201 utilizes any known or future communication technologies to facilitate communication among the various other platforms. Examples of communication technologies include any known or future wired and/or wireless communication pathways, protocols and infrastructure.

### Management Platform 210

The management platform 210 may be configured to carry out various processes describe later.

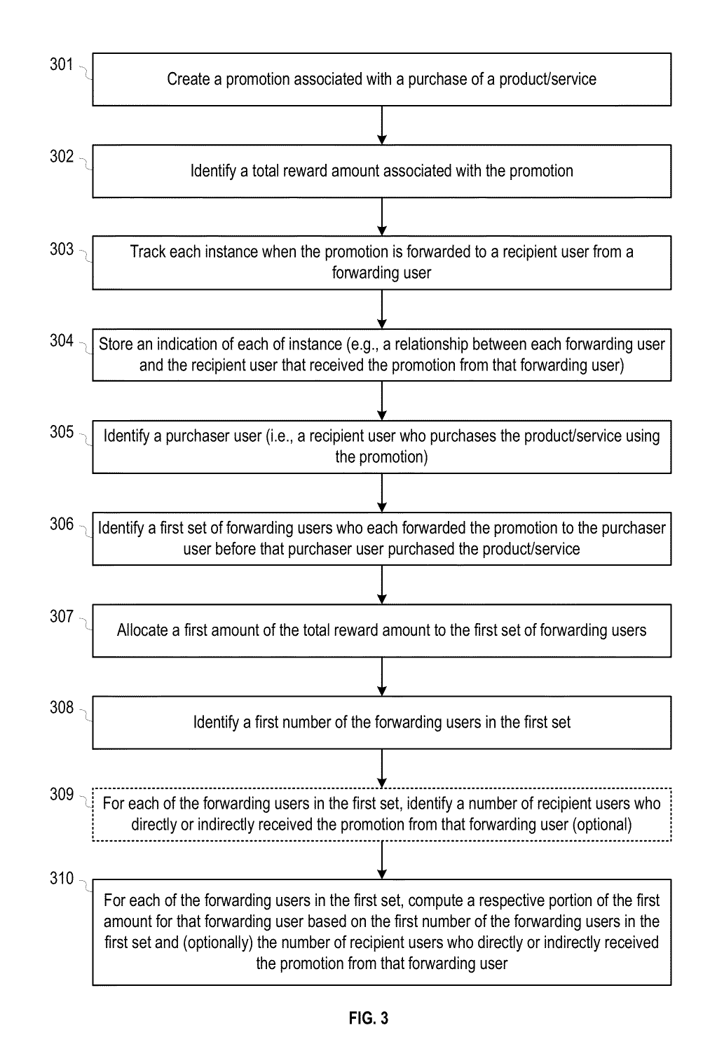

For example, the management platform 210 may carry out operations that allow a forwarding user at the forwarding user platform 220a to forward a promotion to a recipient user (e.g., the purchaser user 230, or another forwarding user at the forwarding user platform 220b). In doing so, the management platform 210 may provide a web-based user interface, application, mail client, or message client through which a forwarding user 120 identifies a recipient user. Once the recipient user is identified, the management platform 210 may then forward the promotion to that recipient user. The management platform 210 may also or alternatively carry out operations that: track forwarding users 220a-n and recipient users of the promotion (e.g., some of the forwarding users 220a-n and/or the purchaser user 230); track use of the promotion by the purchaser user 130 in relation to a transaction involving the purchase of a product or service offered through the business platform 240; identify parameters used to determine reward amounts or points for each forwarding user 120; and/or determine reward amounts or points for each forwarding user 120. Examples of parameters include a level at which the forwarding user 120 forwarded the promotion to another forwarding user 120 or the purchaser user 130, and a degree of forwarding by the forwarding user 120 (e.g., a number of times that forwarding user forwarded the promotion). The above and other operations are described later in association with FIG. 3 through FIG. 10.

### Forwarding User Platform 220

The forwarding user platform 220 may be configured to allow a forwarding user 120 to interact with a forwarding interface provided by the management platform 210. Such a forwarding interface may be accessible via a web browser, application, or email of the forwarding user platform 220, and may permit the forwarding user 120 to input recipient user information into the web browser.

### Purchaser User Platform 230

The purchaser user platform 230 may be configured to allow a purchaser user 130 to receive the promotion from the management platform 210 (or directly from the forwarding user 120 in some cases). Receipt of the promotion may be by any one of various means, including through a website, email, text message or other means to convey the promotion. The purchaser user platform 230 also may be configured to allow the purchaser user 130 to interface with the business platform 140 in order to carry out a transactional purchase of a product or service offered by the business 140 through the business platform 240.

### Business Platform 240

The business platform 240 may be configured to define the promotion. It also may be configured to provide an interface through which a purchaser 130 may purchase a product or service. Examples of business platforms 240 include any website or physical store that is visited by users interested in purchasing the product or service.

The above platforms, or components thereof, may implement various processes that are described below.

### Example Processes

Attention is now drawn to FIG. 3, which depicts a process flow for determining reward amounts for different users who each forwarded a promotion to a purchaser who used that promotion. Another embodiment of FIG. 3 can be used to depict the same process flow for determining reward points for different users who each forwarded a promotion to a purchaser who used that promotion. In accordance with at least one embodiment, the management platform 210 carries out this process. Of course, other platforms may carry out some or all of the process.

As shown in FIG. 3, a promotion associated with a purchase of a product/service is created (301), and a total reward amount or total reward points associated with the promotion is identified (302).

Each instance when the promotion is forwarded to a recipient user from a forwarding user is tracked (303), and an indication of each of forwarding instance is stored (304). For example, a relationship between each forwarding user and the recipient user that received the promotion from that forwarding user may be stored.

A purchaser user is eventually identified, where the purchaser user purchases a product/service using the promotion after that purchaser user received the promotion from one or more forwarding users (305).

Following the purchase of the product/service by the purchaser user, a first set of forwarding users who each forwarded the promotion to the purchaser user before the purchase are identified (306). As will be discussed later, each forwarding user in the first set may be designated as a node in a tree with varying levels of nodes, where the nodes for each of the forwarding users in the first set populate a first level of nodes.

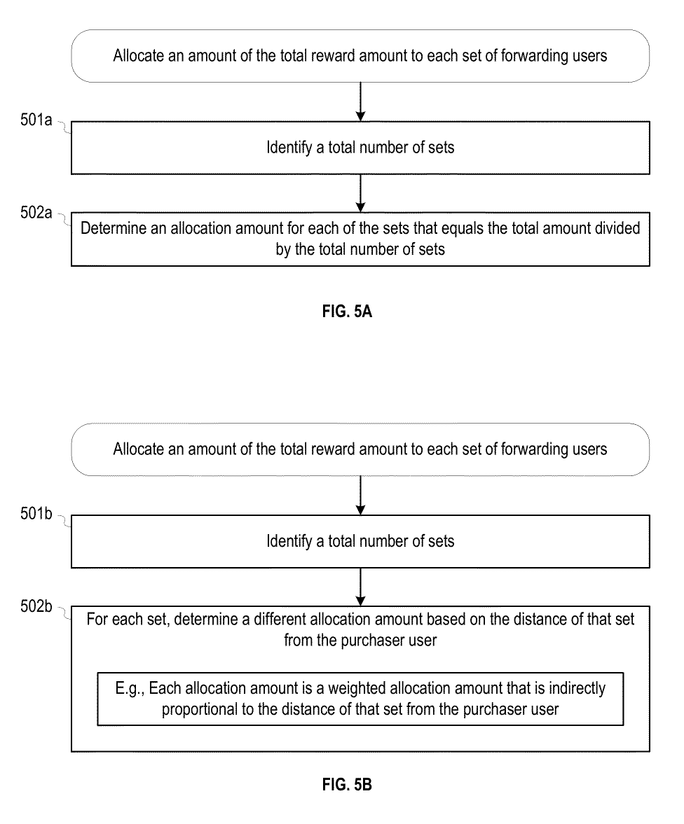

After the first set of forwarding users are identified, an amount of the total reward amount or a percentage of points of the total points from step 302 is allocated to the first set of forwarding users (307). FIG. 5A and FIG. 5B, which are described later, provide different examples of how the amount of the total reward amount or a percentage of points of the total points is allocated.

Before or after the allocation from step 307, the number of the forwarding users in the first set is identified (308), and for each of the forwarding users in the first set, a number of recipient users who directly or indirectly received the promotion from that forwarding user is optionally identified (309).

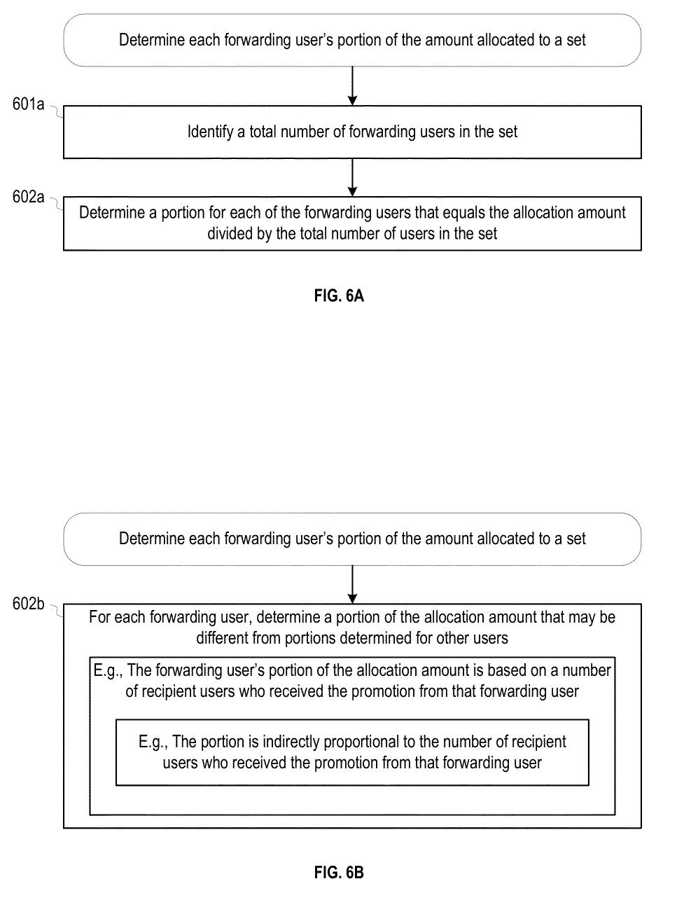

Finally, for each of the forwarding users in the first set, a respective portion of the amount or points for that forwarding user is computed based on the number of the forwarding users in the first set and optionally the number of recipient users who directly or indirectly received the promotion from that forwarding user (310). FIG. 6A and FIG. 6B, which are described later, provide different examples of how each respective portion is computed.

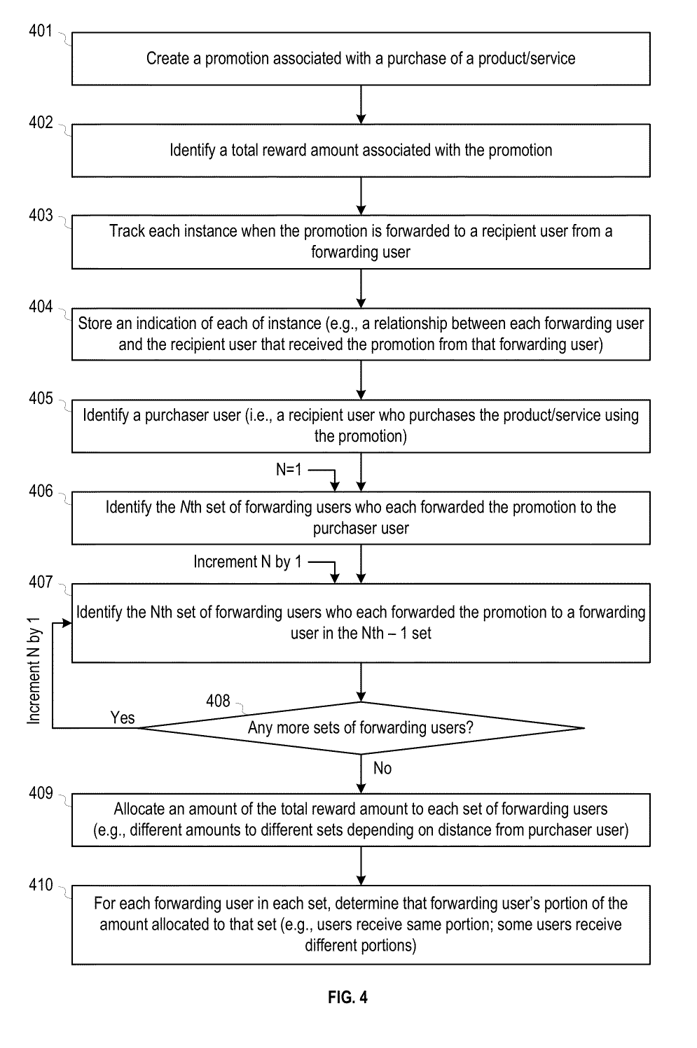

Attention is now drawn to FIG. 4, which depicts a process flow for determining allocations of a reward amount for different levels of direct and indirect forwarding users, and for determining different portions of each allocation at each level for different users at that level. Another embodiment of FIG. 4 can be used to depict the same process flow for determining allocations of reward points for different levels of direct and indirect forwarding users. In accordance with at least one embodiment, the management platform 210 carries out this process. Of course, other platforms may carry out some or all of the process.

As shown in FIG. 4, a promotion associated with a purchase of a product/service is created (401), and a total reward amount or total reward points associated with the promotion is identified (402).

Each instance when the promotion is forwarded to a recipient user from a forwarding user is tracked (403), and an indication of each of forwarding instance is stored (404). For example, a relationship between each forwarding user and the recipient user that received the promotion from that forwarding user may be stored.

A purchaser user is eventually identified, where the purchaser user purchases a product/service using the promotion after that purchaser user received the promotion from one or more forwarding users (405).

Following the purchase of the product/service by the purchaser user, an Nth set of forwarding users who each forwarded the promotion to the purchaser user before the purchase are identified, where N=1 such that the Nth set is the first set (406). As will be discussed later, each forwarding user in the first set may be designated as a node in a tree with varying levels of nodes, where the nodes for each of the forwarding users in the first set populate a first level of nodes.

Other sets of forwarding user are identified. For example, N is incremented by 1, and another Nth set (i.e., second set) of forwarding users who each forwarded the promotion to a forwarding user in the Nth−1 set (i.e., first set) are identified (407). Each forwarding user in the second set may be designated as a node in the tree, where the nodes for each of the forwarding users in the second set populate a second level of nodes because they are two nodes away from a node associated with the purchaser user.

A determination is made as to whether any more sets of forwarding users exist (408). If so, N is incremented by 1, and steps 407 and 408 are repeated, where each additional set of forwarding users creates a new level of nodes.

Once no additional sets of forwarding users exist, a respective amount of the total reward amount or a percentage of points of the total points for each set/level of nodes is determined (409). As discussed below in relation to FIG. 5A and FIG. 5B, each set's amount or a percentage of points may be the same or different depending on that set's distance from purchaser user. When different amounts or a percentage of points are determined, the first set at the first level may be allocated a larger amount of the total reward amount or larger percentage of points of the total points compared to the second set at the second level because forwarding users in the first set provided the promotion directly to the purchaser user while forwarding users in the second set provided the promotion indirectly to the purchaser user through the forwarding users in the first set.

Once the amount or percentage of points for each set is determined, that amount or percentage of points is divided into portions that are allocated to each forwarding user in that set (410). As discussed below in relation to FIG. 6A and FIG. 6B, each user's portion may be the same, or it may be different depending on the amount of times that user forwarded the promotion to other users. When different amounts or percentages of points are determined, a first user may be allocated a larger portion of the set's amount or percentage of points compared to a second user because the first user provided the promotion to fewer users when compared to the number of users who received the promotion from the second user.

Attention is now drawn to FIG. 5A through FIG. 5B, which depict process flows for determining allocations of a reward amount for different levels of nodes. Another embodiment of FIG. 5A through FIG. 5B can be used to depict the same process flows for determining allocations of reward points for different levels of nodes. In accordance with at least one embodiment, the management platform 210 carries out this process. Of course, other platforms may carry out some or all of the process.

As shown in FIG. 5A, a total number of sets is identified (501a), and an allocation amount or points for each of the sets is determined, where each allocation amount or points equals the total amount or points divided by the total number of sets (502a).

As shown in FIG. 5B, a total number of sets is identified (501b), and a different allocation amount or points for each of the sets is determined based on the relative distances of the sets from the purchaser user (502b). In one embodiment, an allocation amount or points for a particular set is a weighted allocation amount or points that is indirectly proportional to the distance of that set from the purchaser user. Thus, a set that is closer to the purchasing user (e.g., the first set from FIG. 4 at a first level) is allocated a larger amount or more points than a set that is farther away from the purchasing user (e.g., the second set from FIG. 4 at a second level).

Attention is now drawn to FIG. 6A through FIG. 6B, which depict process flows for determining different portions of a level's allocated amount for different users at that level. Another embodiment of FIG. 6A through FIG. 6B can be used to depict the same process flows for determining different portions of a level's allocated points for different users at that level. In accordance with at least one embodiment, the management platform 210 carries out this process. Of course, other platforms may carry out some or all of the process.

As shown in FIG. 6A, a total number of forwarding users in a particular set is determined (601a), and a portion for each of the forwarding users is determined, where each portion equals the allocation amount or points divided by the total number of users in the set (602a)

As shown in FIG. 6B, a portion of the allocation amount or points is determined for each user in the set on an individual basis such that different portions may be determined for two or more users (602b). In one embodiment, a forwarding user's portion of the allocation amount or points for a set is based on a number of recipient users who directly and/or indirectly received the promotion from that forwarding user. In one implementation of this embodiment, the portion is indirectly proportional to the number of recipient users who received the promotion from that forwarding user. Thus, a user who provided the promotion to a large volume of users is allocated a smaller portion than a user who provided the promotion to a smaller volume of users.

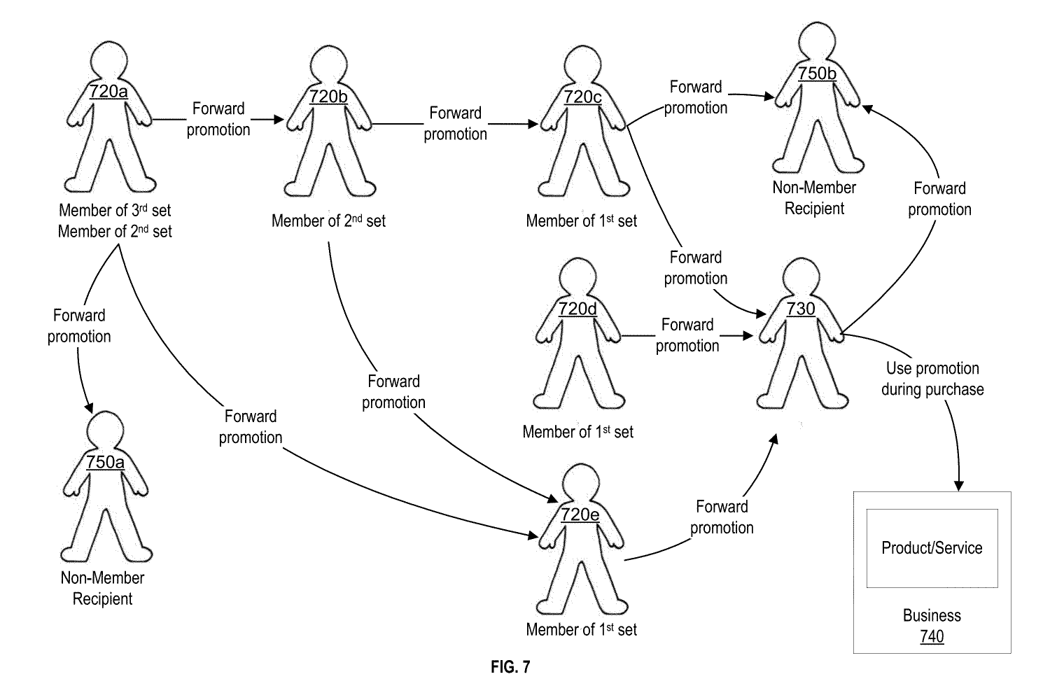

Attention is now drawn to FIG. 7, which pictorially depicts aspects of the processes illustrated in FIG. 4, FIG. 5A through FIG. 5B, and FIG. 6A through FIG. 6B.

As shown in FIG. 7, a promotion is forwarded to a purchaser user 730 from multiple forwarding users 720c-e that form a first set. The forwarding user 720c received the promotion from the forwarding user 720b, and the forwarding user 720e received the promotion from the forwarding user 720a. Thus, the forwarding users 720a and 720b form a second set. Since the forwarding user 720b received the promotion from the forwarding user 720a, the forwarding user 720a also forms a third set.

As illustrated by the forwarding user 720a, the same forwarding user may be a member of multiple sets of forwarding users when that forwarding user 120a forwards the promotion to multiple forwarding users 720b and 720e from different sets. Of course, that forwarding user may be restricted to only one set (e.g., the second set instead of the third set).

Additional users 750a and 750b are shown in FIG. 7 to illustrate that not all users who receive a promotion from a forwarding user 720 are members of sets in relation to a transaction by the purchaser user 730. These non-member users 750a and 750b may, however, reduce portions of reward amounts or points owed to the forwarding users 720a and 720c relative to other forwarding users. For example, the forwarding user 720c may receive a lower portion than the forwarding users 720d and 720e because the forwarding user 720c forwarded the promotion to more users compared to the number of users who received the promotion from the forwarding users 720d and 720e. Penalizing the forwarding user 720c relative to the forwarding users 720d and 720e in this manner may advantageously deter mass marketing that could result in negative sentiment by recipients that tarnishes the brand of the business 740.

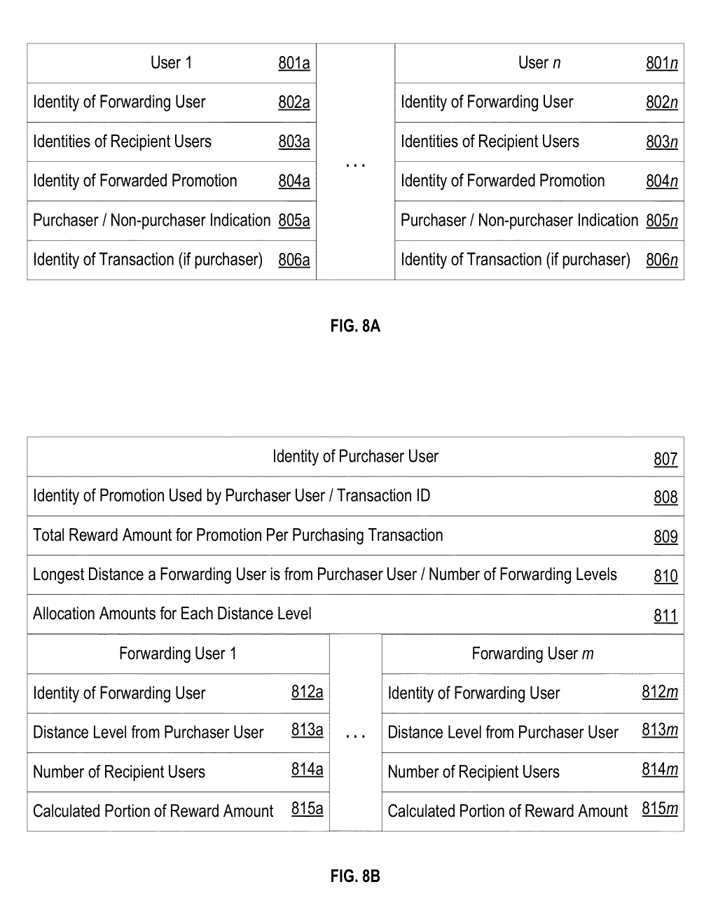

Attention is now drawn to FIG. 8A, which depicts a high-level representation of data collected in relation to forwarding of a promotion by users before a purchase occurs in association with that promotion, where actual implementations of the data may vary. As shown in FIG. 8A, data is collected for multiple users 1−n (801a-n) who forward a promotion to other users. By way of example, the data may include: identities of those forwarding users (802a-n); identities of recipient users who received the promotion from those forwarding users (803a-n); the identity of the forwarded promotion (804a-n); indications as to whether each of the forwarding users is a purchaser or non-purchaser (805a-n); and identities of a transaction if the forwarding user is a purchaser (806a-n).

The identities of the forwarding user and the recipient users may take any form. In one embodiment, personal information like the name of the user is not recorded; instead, the identity may be an identity tied to a third party merchant account used by the user (e.g., PayPal or other merchant accounts). Other identities may include usernames, actual names, email addresses, or other identities known in the art. The identities of the promotion and the transaction may also take any form, including alphanumeric codes, names, or other identities known in the art. A transaction identifier may not be needed where the identifier of the promotion is unique; however, the transaction identifier may be needed where the same promotion identifier is used for all transactions involving the promotion. The indication as to whether a forwarding user is a purchaser may also take any form, including a ‘1’ or ‘0’ (i.e., yes or no). Alternatively, a data block reserved for identities of purchaser users could be populated with the user's identity only when that user is a purchaser.

Attention is now drawn to FIG. 8B, which depicts a high-level representation of data collected and/or generated after a purchase, where actual implementations of the data may vary. As shown in FIG. 8B, data is collected and/or generated for a purchaser user. By way of example, the data may include: the identity of the purchaser user (807); the identity of the promotion used by the purchaser user and/or the transaction ID (808); a total reward amount for the promotion that is designated for each transaction involving the promotion (809); the longest distance a forwarding user is from the purchaser user (e.g., the number of node levels) (810); and allocation amounts for each level (811). The data may also include: identities of forwarding users from whom the purchaser user directly or indirectly received the promotion (812a-m); a distance/level from the purchaser user for each forwarding user (813a-m); a number of recipient users who directly and/or indirectly received the promotion from each forwarding user (814a-m); and a calculated portion of a reward amount for each forwarding user (815a-m). In another embodiment of FIG. 8B, the data may include total reward points for the promotion that is designated for each transaction involving the promotion (809); allocation points for each level (811); and a calculated portion of reward points for each forwarding user (815a-m).

Of the above data, at least the following data is generated in one embodiment: the longest distance a forwarding user is from the purchaser user (e.g., the number of node levels) (810); allocation amounts or points for each level (811); a distance/level from the purchaser user for each forwarding user (813a-m); a number of recipient users who directly and/or indirectly received the promotion from each forwarding user (814a-m); and a calculated portion of a reward amount or points for each forwarding user (815a-m).

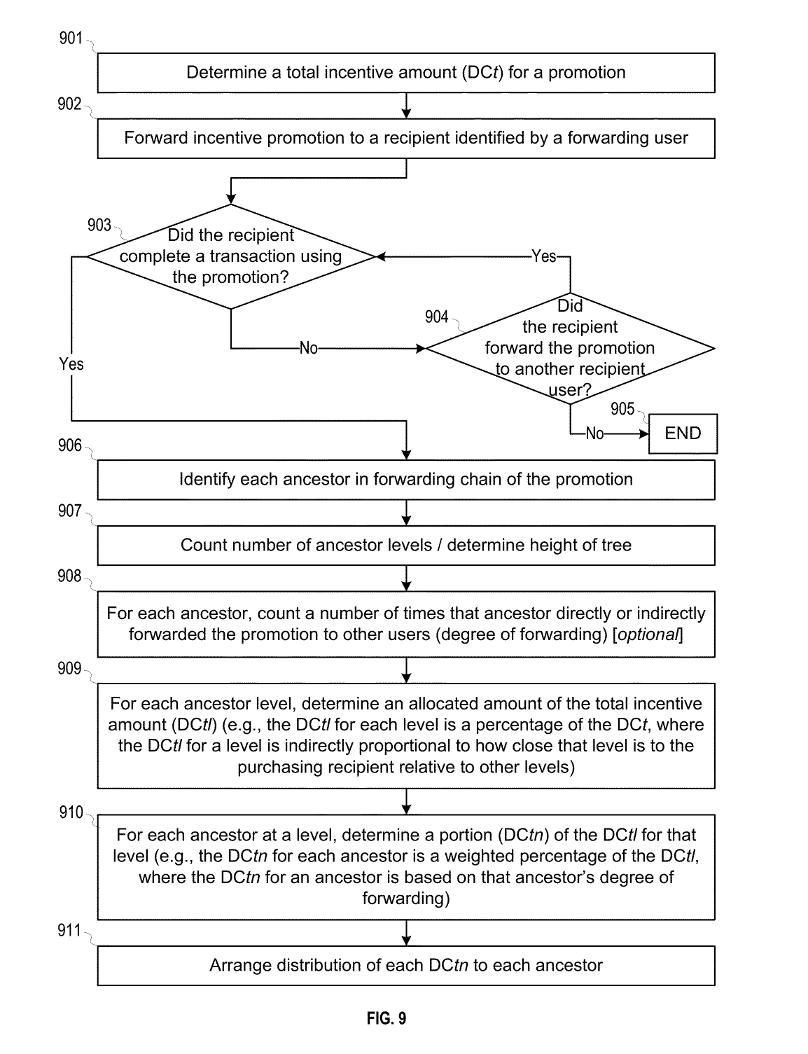

Attention is now drawn to FIG. 9, which depicts a process for determining a hierarchy of user nodes associated with a purchaser node, and also for determining reward amounts for each ancestor node based on the level and degree of forwarding for that ancestor node. Another embodiment of FIG. 9 can be used to depict the same process for also determining reward points for each ancestor node based on the level and degree of forwarding for that ancestor node. In accordance with at least one embodiment, the management platform 210 carries out this process. Of course, other platforms may carry out some or all of the process.

As shown in FIG. 9, a total incentive amount or points (DCt) for a promotion is determined (901), and an incentive promotion is forwarded to a recipient identified by a forwarding user (902), after which a determination is made as to whether the recipient completed a transaction using the promotion (903).

If the recipient did not complete a transaction using the promotion, a determination is made as to whether the recipient forwarded the promotion to another recipient (904), and the process ends if the recipient did not forward the promotion to another recipient. Otherwise, if the recipient forwarded the promotion to another recipient, step 903 is repeated. In some embodiments, the recipient must set up an account in order to forward the promotion so that forwarding of the promotion can be tracked.

If the recipient completed a transaction using the promotion in step 903, each ancestor in a forwarding chain of the promotion to the recipient is identified (906), and the number of ancestor levels (e.g., a height of a node tree) is determined (907).

For each ancestor, a number of times that ancestor directly or indirectly forwarded the promotion to other users (i.e., a degree of forwarding) is optionally determined (908).

Then, for each ancestor level, an allocated amount or points of the total incentive amount or points (DCtl) is determined (909). In one embodiment, the DCtl for each level is a percentage of the DCt, where the DCtl for a level is indirectly proportional to how close that level is to the purchaser relative to other levels.

Finally, a portion (DCtn) of the DCtl for that level is determined for each ancestor at a level (910), and distribution of each DCtn is arranged to each ancestor (911). In one embodiment, the DCtn for each ancestor is a weighted percentage of the DCtl, where the DCtn for an ancestor is based on that ancestor's degree of forwarding.

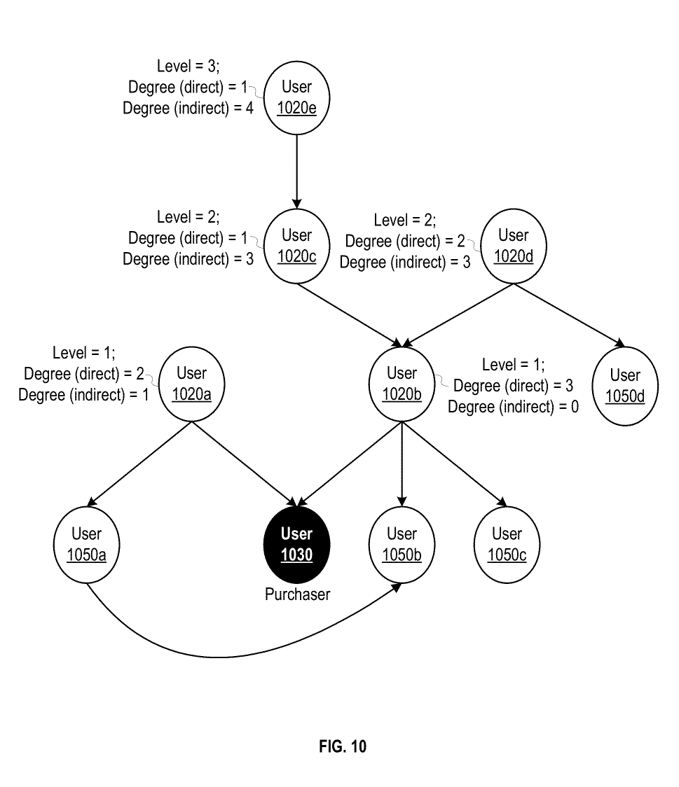

Attention is now drawn to FIG. 10, which illustrates a hierarchy of user nodes associated with different combinations of parameters that specify a distance/level relative to a purchaser node, and a degree of forwarding for each ancestor node.

As shown in FIG. 10, a purchaser node 1030 receives a promotion from an ancestor node 1020a and an ancestor node 1020b. The ancestor node 1020a and the ancestor node 1020b both occupy a first level relative to position of the purchaser node 1030 in the hierarchy of nodes. However, the ancestor node 1020a and the ancestor node 1020b have different degrees of forwarding. For example, the ancestor node 1020a has a degree of direct forwarding set at two (e.g., for forwarding the promotion to two users, including a node 1050a and the purchaser node 1030), and a degree of indirect forwarding set at one (e.g., because the node 1050a forwarded the promotion to a node 1050b). The ancestor node 1020b is shown to have a degree of direct forwarding set at three (e.g., for forwarding the promotion to three users, including the node 1050b, a node 1050c, and the purchaser node 1030), and a degree of indirect forwarding set at zero (e.g., because none of the node 1050b, the node 1050c, and the purchaser node 1030 forwarded the promotion to another user). Level and degree parameters for the other nodes 1020c, 1020d and 1020e are shown in FIG. 10.

It is noted that different implementations of FIG. 10 may use the degree of direct forwarding and/or the degree of indirect forwarding when computing a user's share of the total reward amount or points (e.g., FIG. 3) or the total incentive amount or points (e.g., FIG. 9). Thus, either degree is optional.

### Creation of Node Tree

The following examples of collected and generated data are provided in order to illustrate one embodiment for creating a hierarchy of nodes:

Forwarder Table

| | | |
|---|---|---|
| User Identity | Promotion Identity | Identities 1-n |
| (Forwarder) | | (Receivers 1-n) |

Purchaser Table

| | | |
|---|---|---|
| User Identity (Purchaser) | Promotion Identity | Transaction Identity |

Transaction Ancestor Table

| | | |
|---|---|---|
| User Identity (Forwarder) | Forwarding Level | Degree of Forwarding |

The following example of a process that uses the above data is provided in order to illustrate the embodiment for creating a hierarchy of nodes:

Step 1: When a user purchases a product or service using a Promotion Identity, set that user's User Identity (Purchaser) in the Purchaser Table along with the Promotion Identity, and create a Transaction Identity.

Step 2: In Forwarder Tables, search the Identities 1−n for the User Identity (Purchaser).

Step 3: Set N=1, and create Transaction Ancestor Tables for each User Identity (Forwarder) with one of the Identities 1−n equal to the User Identity (Purchaser), and set the Forwarding Level to N.

Step 4: Increment N by 1, and create Transaction Ancestor Tables for each User Identity (Forwarder) with one of the Identities 1−n that equal to a User Identity (Forwarder) from the previous step, and set the Forwarding Level to N.

Step 5: Repeat Step 4 until no data is returned.

Step 6: For each User Identity (Forwarder) in a Transaction Ancestor Table, count the number of Identities 1−n from the Forwarder Table for that User Identity (Forwarder), and set Degree of Forwarding to this number.

### Advantages

Practice of the methods disclosed herein offer many advantages over predecessor approaches, including: (a) providing enhanced computer operations that would otherwise be unavailable without practicing the methods disclosed herein; (b) connecting users and businesses who would otherwise be unable to connect with each other without practicing the methods disclosed herein; (c) allowing certain users to participate in activities that are otherwise unavailable to those users without practice of the methods disclosed herein; and/or (d) creating new information and using that new information to enhance computer operations and user experience.

Various methods disclosed herein improve various technical fields (e.g., marketing fields) by offering the following solutions to problems encountered in those fields: providing users incentives to promote a product or service while allowing those users to maintain control of their personal information; and achieving targeting marketing by leveraging user knowledge of other users to identify potential buyers instead of mass marketing to every possible user.

### Other Aspects Related to Systems & Methods

Functionality and operation disclosed herein may be embodied as one or more methods implemented, in whole or in part, by machine(s)—e.g., processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more processors cause the processors to carry out the method(s). Apparatuses operable to implement the method(s) are also contemplated.

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency.

By way of example, not by way of limitation, method(s), systems(s) or other means may include or be operable perform the following: identify, based on input received from a commercial entity, a total reward amount or points associated with a promotion; identify a purchase of a product/service by a purchaser using the promotion; identify a first group of one or more users who each provided the promotion to the purchaser before the purchase; and determine, for each user of the first group, a percentage of the total reward amount or points that is owed to that user.

In one embodiment, the first group of users does not include the purchaser.

In one embodiment, the percentage of the total reward amount or points that is owed to each user of the first group is the same for each user.

In one embodiment, the percentages of the total reward amount or points that are owed to at least two of the users of the first group are different.

Method(s), system(s) or other means may further or alternatively include or be operable to perform the following: determine, for each user of the first group, a number of times that user provided the promotion to one or more different users other than the purchaser. In one embodiment, the percentage of the total reward amount or points that is owed to each user of the first group depends on a number of times that user provided the promotion to the one or more different users.

In one embodiment, the percentages of the total reward amount or points that are owed to any two users of the first group are different when each of those two users provided the promotion to a different number of the one or more different users.

In one embodiment, a first percentage of the total reward amount or points that is owed to a first user of the first group is less than a second percentage of the total reward amount or points that is owed to a second user of the first group when a first number of times the first user provided the promotion to the one or more different users is greater than a second number of times the second user provided the promotion to the one or more different users.

Method(s), system(s) or other means may further or alternatively include or be operable to perform the following: identify a second group of one or more users who each provided the promotion to at least one of the users of the first group before the purchase; and determine, for each user of the second group, a percentage of the total reward amount or points that is owed to that user.

Method(s), system(s) or other means may further or alternatively include or be operable to perform the following: identify a second group of one or more users who each provided the promotion to at least one of the users of the first group before the purchase; and determine, for each user of the second group, a percentage of the total reward amount or points that is owed to that user. In one embodiment, the percentage of the total reward amount or points that is owed to each user of the first group is the same for each user of the first group, the percentage of the total reward amount or points that is owed to each user of the second group is the same for each user of the second group, and the percentage of the total reward amount or points that is owed to each user of the first group is more than the percentage of the total reward amount or points that is owed to each user of the second group.

Method(s), system(s) or other means may further or alternatively include or be operable to perform the following: identify a second group of one or more users who each provided the promotion to at least one of the users of the first group before the purchase; determine, for each user of the second group, a percentage of the total reward amount or points that is owed to that user; determine, for each user of the first group, a number of times that user provided the promotion to one or more different users other than the purchaser, wherein the percentage of the total reward amount or points that is owed to each user of the first group depends on a number of times that user provided the promotion to the one or more different users; and determine, for each user of the second group, a number of times that user provided the promotion to the one or more different users, wherein the percentage of the total reward amount or points that is owed to each user of the second group depends on a number of times that user provided the promotion to the one or more different users.

In one embodiment, the percentages of the total reward amount or points that are owed to any two users of the first group are different when each of those two users provided the promotion to a different number of users other than the purchaser, and wherein the percentages of the total reward amount or points that are owed to any two users of the second group are different when each of those two users provided the promotion to a different number of users other than the purchaser.

In one embodiment, a first percentage of the total reward amount or points that is owed to a first user of the first group is less than a second percentage of the total reward amount or points that is owed to a second user of the first group when a first number of times the first user provided the promotion to the one or more different users is greater than a second number of times the second user provided the promotion to the one or more different users, and a third percentage of the total reward amount or points that is owed to a third user of the second group is less than a fourth percentage of the total reward amount or points that is owed to a fourth user of the second group when a third number of times the third user provided the promotion to the one or more different users is greater than a fourth number of times the fourth user provided the promotion to the one or more different users.

In one embodiment, each user in the first group is identified from a stored association between that user's identity and an identity of the purchaser.

By way of example, not by way of limitation, other method(s), systems(s) or other means may include or be operable perform the following: identify a purchaser node; identify each ancestor node associated with the purchaser node; identify each ancestor level at which at least one of the ancestor nodes is located; compute, based on the number of ancestor levels, a portion of a total reward amount or points for each of the ancestor levels, wherein a different portion of the total reward amount or points is computed for each ancestor level; and compute, for each ancestor node at each ancestor level, a percentage of that ancestor level's portion owed to that ancestor node.

In one embodiment, wherein the purchaser node represents a purchaser who purchased a product/service using a promotion, each ancestor node at a first ancestor level of the ancestor levels represents a user who provided the promotion to the purchaser, and each ancestor node at all other ancestor levels represents a user who did not provide the promotion to the purchaser.

In one embodiment, a first portion of the total reward amount or points computed for a first ancestor level is greater than a second portion of the total reward amount or points computed for a second ancestor level when the first ancestor level is closer to the purchaser node than the second ancestor level.

Method(s), system(s) or other means may further or alternatively include or be operable to perform the following: identify, for each ancestor node, a number of descendant nodes of that ancestor node. In one embodiment, the percentage owed to that ancestor node is based on the number of descendant nodes of that ancestor node.

In one embodiment, a first percentage owed to a first ancestor node of a first ancestor level is less than a second percentage owed to a second ancestor node of the first ancestor level when a first number of descendant nodes of the first ancestor node is greater than a second number of descendant nodes of the second ancestor node.

Method(s), system(s) or other means may further or alternatively include or be operable to perform the following: identify each user of the second group who provided the promotion to at least one of the users of the first group before the purchase; and determine, for each user of the second group, a percentage of the total reward amount or points that is owed to that user, wherein the percentage of the total reward amount or points that is owed to each user of the first group is depends on whether that user received the promotion from a user of the second group.

In one embodiment, a first percentage of the total reward amount or points for a first user of the first group who received the promotion from a user of the second group is less than a second percentage of the total reward amount or points for a second user of the first group who did not receive the promotion from a user of the second group.

By way of example, not by way of limitation, method(s), systems(s) or other means for determining weights in relation to promoting a product or service that is purchased by a purchaser may include or be operable perform the following: identifying, based on input received from a commercial entity, a total reward amount associated with a promotion; identifying a purchase of a product/service by a purchaser using the promotion; identifying a first group of one or more users who each provided the promotion to the purchaser before the purchase; for each user of the first group, determining a weight; and for each user of the first group, using the weight to determine a proportional percentage of the total reward amount that is owed to that user. In one embodiment, the weight for each user in the first group is the same. In one embodiment, the weight for each group is different (e.g., a first weight for each user of the first group is different than a second weight for each user of a second group, where each user of the second group provided the promotion to a user of the first group). In one embodiment, a larger weight is allocated to the group that is closer to the purchasing user (e.g., a larger weight and a larger proportional percentage of the total reward amount for the first group, and smaller weight and a smaller proportional percentage of the total reward amount for the second group).

By way of example, not by way of limitation, method(s), systems(s) or other means may include or be operable perform the following: identify, based on input received from a commercial entity, a total number of points associated with a promotion; identify a purchase of a product/service by a purchaser using the promotion; identify a first group of one or more users who each provided the promotion to the purchaser before the purchase; and determine, for each user of the first group, a percentage of the total number of points that is owed to that user.

An output from one system may cause another system to perform a method even if intervening steps occur between the output and performance of the method.

Any method step or feature disclosed herein may be expressly restricted from a claim for various reasons like achieving reduced manufacturing costs, lower power consumption, and increased processing efficiency.

The illustrative methods described herein may be implemented, performed, or otherwise controlled by suitable hardware known or later-developed by one of skill in the art, or by firmware or software executed by processor(s), or any combination of hardware, software and firmware. Software may be downloadable and non-downloadable at a particular system. Such software, once loaded on a machine, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement any or all of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

Application programs may carry out aspects by receiving, converting, processing, storing, retrieving, transferring and/or exporting data, which may be stored in a hierarchical, network, relational, non-relational, object-oriented, or other data source.

All of the information disclosed herein may be represented by data, and that data may be transmitted over any communication pathway using any protocol, stored on data source(s), and processed by a processor. Transmission of data may be carried out using a variety of wires, cables, radio signals and infrared light beams, and an even greater variety of connectors, plugs and protocols even if not shown or explicitly described. Systems may exchange information with each other using any communication technology. Data, instructions, commands, information, signals, bits, symbols, and chips and the like may be represented by voltages, currents, electromagnetic waves, magnetic fields or particles, or optical fields or particles.

Different systems/platforms disclosed herein may be geographically dispersed from one another in different regions (e.g., cities, countries), such that different method steps are performed in different regions and by different systems/platforms.

Features in system figures that are illustrated as rectangles may refer to hardware, firmware or software. It is noted that lines linking two such features may be illustrative of data transfer between those features. Such transfer may occur directly between those features or through intermediate features. Where no line connects two features, transfer of data between those features is contemplated unless otherwise stated.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for tracking user activity in relation to promoting a product or service that is purchased by a purchaser, the method comprising:
identifying, based on input received from a commercial entity, a total reward amount associated with a promotion;
identifying a purchase of a product/service by a purchaser using the promotion;
identifying a first group of one or more users who each provided the promotion to the purchaser before the purchase; and
determining, for each user of the first group, a percentage of the total reward amount that is owed to that user.

2. The method of claim 1, wherein the first group of users does not include the purchaser.

3. The method of claim 1, wherein the percentage of the total reward amount that is owed to each user of the first group is the same for each user.

4. The method of claim 1, wherein the percentages of the total reward amount that are owed to at least two of the users of the first group are different.

5. The method of claim 1, wherein the method further comprises:
determining, for each user of the first group, a number of times that user provided the promotion to one or more different users other than the purchaser,
wherein the percentage of the total reward amount that is owed to each user of the first group depends on a number of times that user provided the promotion to the one or more different users.

6. The method of claim 5, wherein the percentages of the total reward amount that are owed to any two users of the first group are different when each of those two users provided the promotion to a different number of the one or more different users.

7. The method of claim 5, wherein a first percentage of the total reward amount that is owed to a first user of the first group is less than a second percentage of the total reward amount that is owed to a second user of the first group when a first number of times the first user provided the promotion to the one or more different users is greater than a second number of times the second user provided the promotion to the one or more different users.

8. The method of claim 1, wherein the method further comprises:
identifying a second group of one or more users who each provided the promotion to at least one of the users of the first group before the purchase; and
determining, for each user of the second group, a percentage of the total reward amount that is owed to that user.

9. The method of claim 1, wherein the method further comprises:
identifying a second group of one or more users who each provided the promotion to at least one of the users of the first group before the purchase; and
determining, for each user of the second group, a percentage of the total reward amount that is owed to that user,
wherein the percentage of the total reward amount that is owed to each user of the first group is the same for each user of the first group,
wherein the percentage of the total reward amount that is owed to each user of the second group is the same for each user of the second group, and
wherein the percentage of the total reward amount that is owed to each user of the first group is more than the percentage of the total reward amount that is owed to each user of the second group.

10. The method of claim 1, wherein the method further comprises:
identifying a second group of one or more users who each provided the promotion to at least one of the users of the first group before the purchase;
determining, for each user of the second group, a percentage of the total reward amount that is owed to that user;
determining, for each user of the first group, a number of times that user provided the promotion to one or more different users other than the purchaser, wherein the percentage of the total reward amount that is owed to each user of the first group depends on a number of times that user provided the promotion to the one or more different users; and
determining, for each user of the second group, a number of times that user provided the promotion to the one or more different users, wherein the percentage of the total reward amount that is owed to each user of the second group depends on a number of times that user provided the promotion to the one or more different users.

11. The method of claim 10, wherein the percentages of the total reward amount that are owed to any two users of the first group are different when each of those two users provided the promotion to a different number of users other than the purchaser, and wherein the percentages of the total reward amount that are owed to any two users of the second group are different when each of those two users provided the promotion to a different number of users other than the purchaser.

12. The method of claim 10,
wherein a first percentage of the total reward amount that is owed to a first user of the first group is less than a second percentage of the total reward amount that is owed to a second user of the first group when a first number of times the first user provided the promotion to the one or more different users is greater than a second number of times the second user provided the promotion to the one or more different users, and
wherein a third percentage of the total reward amount that is owed to a third user of the second group is less than a fourth percentage of the total reward amount that is owed to a fourth user of the second group when a third number of times the third user provided the promotion to the one or more different users is greater than a fourth number of times the fourth user provided the promotion to the one or more different users.

13. The method of claim 1, wherein each user in the first group is identified from a stored association between that user's identity and an identity of the purchaser.

14. A non-transitory machine-readable medium embodying program instructions adapted to be executed to implement a method for tracking user activity in relation to promoting a product or service that is purchased by a purchaser, the method comprising:
identifying, based on input received from a commercial entity, a total reward amount associated with a promotion;
identifying a purchase of a product/service by a purchaser using the promotion;
identifying a first group of one or more users who each provided the promotion to the purchaser before the purchase; and
determining, for each user of the first group, a percentage of the total reward amount that is owed to that user.

15. A method for tracking user activity in relation to promoting a product or service that is purchased by a purchaser, the method comprising:
identifying, based on input received from a commercial entity, a total number of points associated with a promotion;
identifying a purchase of a product/service by a purchaser using the promotion;
identifying a first group of one or more users who each provided the promotion to the purchaser before the purchase; and
determining, for each user of the first group, a percentage of the total number of points that is owed to that user.
